(19) United States
(12) Patent Application Publication
(10) Pub. No.: US 2025/0318479 A1
(43) Pub. Date: Oct. 16, 2025

(54) SELF-SUSTAINING INDOOR FARMING SYSTEM

(71) Applicant: Idealab Studio, LLC, Pasadena, CA (US)

(72) Inventors: William Tod Gross, Pasadena, CA (US); Andrea Pedretti, Thousand Oaks, CA (US)

(21) Appl. No.: 19/176,794

(22) Filed: Apr. 11, 2025

Related U.S. Application Data
(60) Provisional application No. 63/632,995, filed on Apr. 11, 2024.

(51) Int. Cl. A01G 9/24; F24S 20/20; F24S 23/70

(52) U.S. Cl. CPC A01G 9/243; F24S 20/20; F24S 23/70; F24S 2023/87

(57) ABSTRACT

A self-sustaining farming system includes a building with aperture(s) in a side of the building. Reflected sunlight from heliostats adjacent the building is directed to and passes through the aperture(s) and through light tube(s) that direct light onto plants disposed inside the building proximate the light tube(s). A portion of the reflected sunlight is directed to a photovoltaic panel for generating electricity that is used by components and electronics in the building. A portion of the reflected sunlight can be converted to heat that can be stored in a heat storage unit for use in maintaining the internals of the building at a controlled temperature and/or to generate water from air, the water used to irrigate the plants in the building. The system utilizes all of the spectrum of sunlight to provide a self-sustaining farming environment that can operate in remote locations (e.g., desert) using only sunlight to grow plants.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to an indoor farming system and method, and more particularly to a self-sustained indoor farming system and method.

### Description of the Related Art

There is an increased focus on reducing the use of fossil fuels to reduce the greenhouse gas emissions to the atmosphere, including reducing emissions in farming. Use of indoor farming has increased; one benefit of indoor farming is a reduction in water use. Current methods for indoor farming utilize a greenhouse type environment, where there are rows of plants inside a sealed environment powered with LED lighting. These methods are expensive and use a significant amount of power. Indoor farming requires power to grow the plants, and such power generally come from an electric grid, limiting where indoor farming facilities can be built. In some cases, solar power from Photovoltaic (PV) panels, instead of power from an electric grid, can be used for indoor farming facilities. For example, PV panels have been used in some cases to generate electricity to power the LED lighting. However, given the efficiency rate of PV panels and amount of power required by LEDs, a significant amount of land is required for PV panel fields to generate the amount of power required by LEDs. Additionally, dedicated water sources are needed for existing indoor farming systems, making them unsuitable for remote (e.g., desert) environments.

### SUMMARY

Accordingly, there is a need for improved indoor farming systems and methods that are self-sustaining and can be powered by efficient renewable energy sources.

In accordance with one aspect of the disclosure, an indoor farming system is provided that utilizes concentrated light reflected from the sun to provide light for growing plants. The farming system includes a building that houses plants, and a field of heliostats arranged proximate one or more sides of the building. The heliostats reflect sunlight onto one or more apertures in the one or more sides of the building and into one or more light tubes (or fiber optic tubes) inside the building that are connected to the one or more apertures. Said light is distributed via the light tubes to the plants in the building. The light in the light tubes shines down onto growing plants below (e.g., via openings in the light tubes or fiber optic tubes distributed over the plants). In one implementation, the size of the one or more apertures is adjustable to adjust an amount of light that is directed to the plants (e.g., one aperture being larger in size to direct relatively more light to plants, such as seedlings, and another aperture being smaller in size to direct relatively less light to plants, such as full grown plants).

In accordance with one aspect of the disclosure, an indoor farming method is provided. The method can include the step of reflecting sunlight with one or more heliostats in a heliostat field onto one or more apertures on one or more sides of a building that houses plants, said light directed to the plants via one or more light tubes (e.g., fiber optic tubes) connected to the one or more apertures. The method can also include the step of varying (automatically) a size of the one or more apertures to vary the amount and intensity of the light entering the light tubes connected to the one or more apertures, e.g., depending on the needs of the plants to which light from the light tubes is distributed. In one example, the method also includes the step of generating electricity with at least a portion of the light passing through the one or more apertures. In one example, the method also includes the step of generating and storing heat from at least a portion of the light passing through the one or more apertures. In another example, the method further includes the step of generating water from air (atmospheric water generation) with said generated and/or stored heat and distributing the generated water (e.g., via a drip irrigation system) to the plants in the building.

In some aspects, the techniques described herein relate to a self-sustaining farming system, including: a building having an aperture on a side of the building, the aperture configured to receive reflected sunlight from one or more heliostats in a heliostat field proximate the building; and a light tube extending into the building from the aperture, the light tube configured to direct light along a length of the light tube and direct said light onto one or more plants disposed inside the building.

In some aspects, the techniques described herein relate to a self-sustaining farming system, including: a heliostat field including a plurality of heliostats; a building proximate the heliostat field, the building having an aperture on a side of the building, the aperture configured to receive reflected sunlight from one or more of the plurality of heliostats in the heliostat field; a compound parabolic concentrator proximate the aperture and configured to direct and concentrate the reflected sunlight onto the aperture; and a light tube extending into the building from the aperture, the light tube configured to direct light along a length of the light tube and direct said light via one or more concentrators onto one or more plants disposed inside the building.

In some aspects, the techniques described herein relate to a self-sustaining farming system, including: a building proximate having an aperture on a side of the building, the aperture configured to receive reflected sunlight from one or more heliostats; a compound parabolic concentrator proximate the aperture and configured to direct and concentrate the reflected sunlight onto the aperture; and a light tube extending into the building from the aperture, the light tube configured to direct light along a length of the light tube and direct said light via one or more concentrators onto one or more plants disposed inside the building.

In some aspects, the techniques described herein relate to a self-sustaining farming system, including: a building having an aperture on a side of the building, the aperture configured to receive reflected sunlight from one or more heliostats; and a light tube extending into the building from the aperture, the light tube configured to direct light along a length of the light tube and direct said light via one or more concentrators onto one or more plants disposed inside the building.

### BRIEF DESCRIPTION OF THE DRAWINGS

FIG. 1 is a schematic view of an indoor farming system.

FIG. 2 is a schematic view of one or more heliostats directing light into a light tube of an indoor farming system.

FIG. 3 is a schematic view of light tubes distributed in a building of an indoor farming system.

FIG. 4A is a schematic view of the light tubes of FIG. 3.

FIG. 4B is a schematic view of a variation of the light tubes in FIG. 3.

FIG. 4C is a schematic view of a variation of the light tubes in FIG. 3.

FIG. 4D is a schematic view of a variation of the light tubes in FIG. 3.

FIG. 4E is a schematic view of a variation of the light tubes in FIG. 3.

FIG. 4F is a schematic view of a variation of the light tubes in FIG. 3.

FIG. 4G is a schematic view of a variation of the light tubes in FIG. 3.

FIG. 4H is a schematic view of a variation of the light tubes in FIG. 3.

FIG. 5 shows a schematic view of an alternative implementation of an indoor farming system.

FIG. 6 is a flowchart of an illustrative process for controlling how much light goes to the plants in the system.

### DETAILED DESCRIPTION

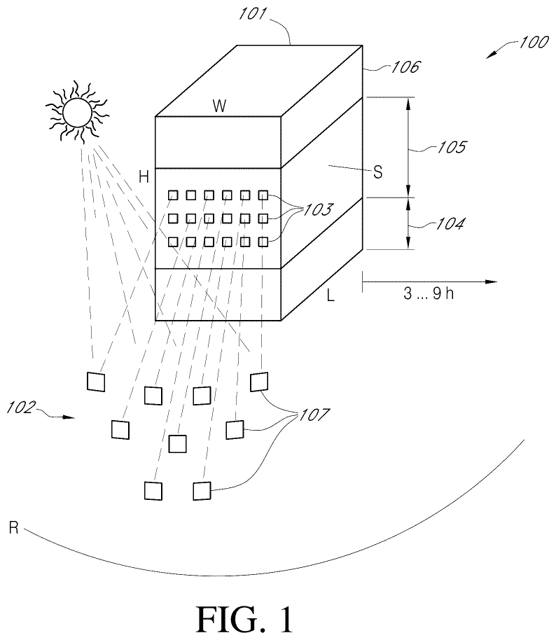

FIG. 1 shows a schematic view of an indoor farming system 100 (hereafter “the system”) including a building 101 and an adjacent heliostat field 102 with a plurality of heliostats 107 to produce light and electricity (and/or heat) for an indoor farming operation. The building 101 can house a plurality of plants, for example distributed in a plurality of rows. The plurality of rows can be spaced from each other (e.g., spaced horizontally and/or vertically). The plurality of plants can vary in type and in stages of growth (e.g., some can be seedlings, some can be fully grown plants, some can be in an intermediate stage of growth between a seedling and a fully grown plant). Advantageously, as further discussed below, the indoor farming system 100 is self-sustaining and can be utilized in remote locations (e.g., desert locations) disconnected from a power grid or a dedicated water source.

The building 101 can have one or more apertures 103 (e.g., openings) on one or more sides S of the building 101 (e.g., on south facing sides, north facing sides, east facing sides and/or west facing sides of the building). The adjacent heliostat field 102 is outside the building and proximate (e.g., adjacent) to the one or more sides S of the building 101 containing the apertures 103. The heliostats 107 of the heliostat field 102 reflect sunlight onto the apertures 103 and, as discussed further below, at least a portion of the light that passes through the apertures 103 is directed to the rows of plants via the light tubes 201. In one example, where the building 101 has multiple apertures 103 on the side S of the building 101, a subset of the heliostats 107 of the heliostat field 102 reflect sunlight into each of the apertures 103 of the building 101. For example, if the building 101 has one hundred apertures 103 and there are one thousand heliostats 107 in the heliostat field 102, in one example every ten heliostats 107 reflect sunlight into one of the apertures 103 on the side S of the building 101. In another example, every fifty heliostats 107 reflect sunlight into one of the apertures 103 on the side S of the building 101. In still another example, every one-hundred heliostats 107 reflect sunlight into one of the apertures 103 on the side S of the building 101. Other suitable combinations are possible.

The building 101 can have a roof and walls. In one implementation, the building 101 may be a shipping container. In another implementation, the building 101 can be multiple shipping containers (e.g., stacked shipping containers). The building 101 can have a single floor or multiple floors inside, each housing one or more (e.g., multiple) rows of plants. The building 101 can be sealed to prevent heat and water from leaving or entering the building 101. The building 101 can have a height H, a length L, and a width W. In one example, the height H of the building can be approximately 120 meters. In one implementation, the length L of the building 101 is longer than the width W of the building 101. In another implementation, the width W of the building 101 is approximately equal to the length L of the building 101. However, the building 101 can have other suitable dimensions for the height H, length L, and width W.

The aperture(s) 103 on the side S of the building 101 can be small opening(s) in the side S of the building. In one implementation, the aperture(s) 103 may have a height and width of 1 m×1 m. However, the apertures 103 can have other suitable dimensions. In one implementation, the size of the aperture(s) 103 is fixed. In another implementation, the size of the aperture(s) 103 is fixed and can vary in size. In another example, the size of the aperture(s) 103 is selectively adjustable (e.g., the size of the aperture(s) 103 can be selectively adjustable, such as with a shutter mechanism actuated using power from the PV panel(s), discussed further below, to change the size of the aperture(s) 103). For example, the size of the aperture(s) 103 may vary (e.g., may automatically be varied via computer control) based on the type of plant the light is being directed to and/or the size (stage of growth) of the plant. For example, the light may be directed to small plants, large plants, seeds, seedlings, young plants, or mature plants. As such, the ideal amount of light for each plant type and/or size (stage of growth) varies and therefore the size of the aperture(s) 103 may vary correspondingly (e.g., may be varied automatically under computer control) to adjust the amount of light being directed via the associated light tube(s) 201 to the particular plant.

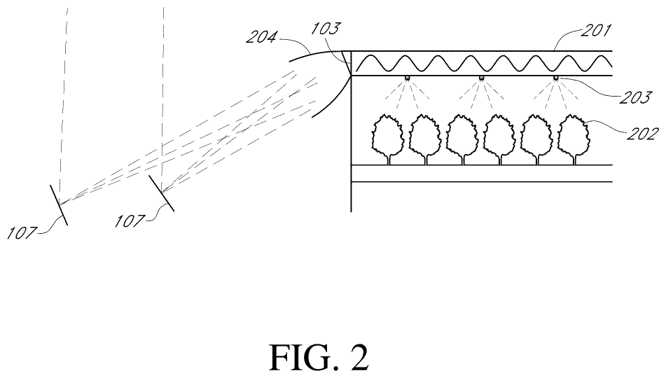

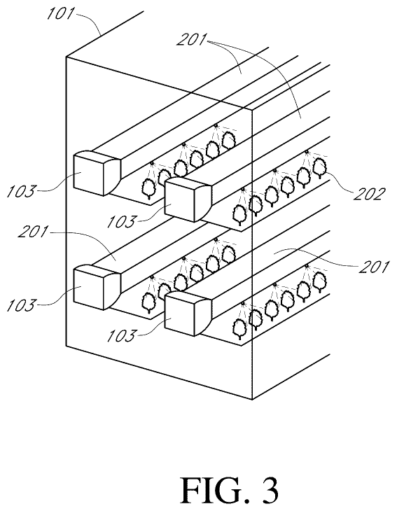

The apertures 103 may be connected to the light tubes 201 inside the building 101 and can direct light they receive from the heliostats 107 of the heliostat fields 102 into the associated light tubes 201. One or more light tubes 201 can be connected to a single aperture 103. In one example, a single light tube 201 is connected to a single aperture 103. In some implementations, for example shown in FIGS. 2-3, a compound parabolic collector 204 (hereinafter “CPC”) can be disposed at or proximate the aperture 103 and can concentrate the reflected sunlight directed at the aperture 103 by the heliostats 107 to direct said light into the light tube 201. In other implementations, the compound parabolic collectors can be excluded.

FIG. 2 is a schematic view of one or more (e.g. multiple) heliostats 107 reflecting sunlight and directing it to a light tube 201 via an aperture 103 in the building 101, such as the building 101 in FIG. 1. For clarity, the walls of the building 101 are excluded from FIG. 2 to illustrate the features of the light tube 201. Said light that enters via the aperture 103 travels down the light tube 201 and directs light down onto the plants 202 in a row disposed under the light tube 201. In one implementation, the light tube 201 can include one or more (e.g. multiple) concentrators 203 (e.g., spaced) along the length of the light tube 201, where light is directed onto the plants 202 in the row from the light tube 201 via the concentrator(s) 203. In one example, the concentrator(s) 203 can include one or more lenses. In another example, the concentrator(s) 203 can be apertures or openings in the wall of the light tube 201. In one example, the light tube 201 can have a constant diameter or cross-section along its length. In another example, the light tube 201 have a diameter or cross-section that varies along the length of the light tube 201. Though only one light tube 201 is shown in FIG. 2, one of skill in the art will recognize that the building 101 can have multiple light tubes 201, each associated with one of the apertures 103. Where the building 101 has multiple light tubes 201, the light tubes 201 may have varying dimensions. In one implementation, the dimensions of the light tubes 201 may vary according to the type of plants they are providing light to.

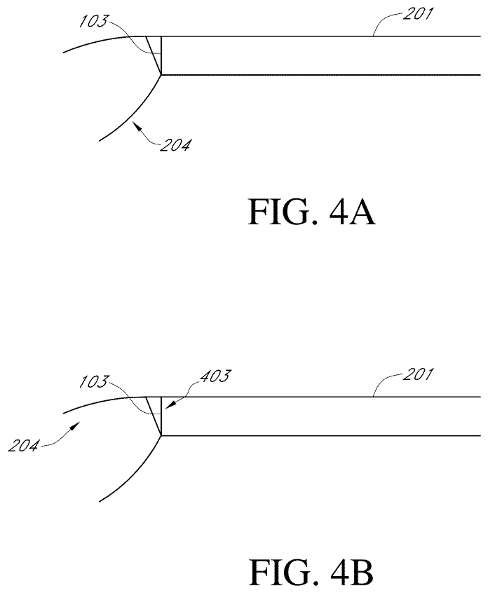

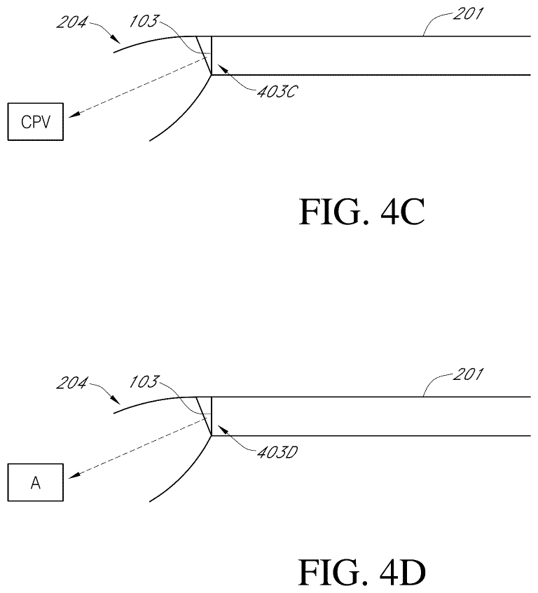

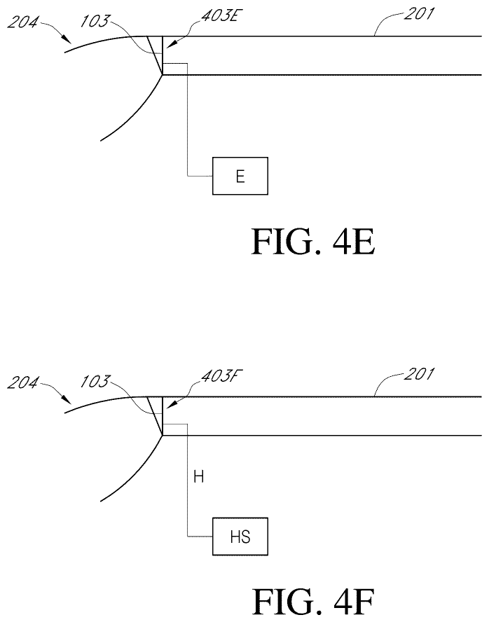

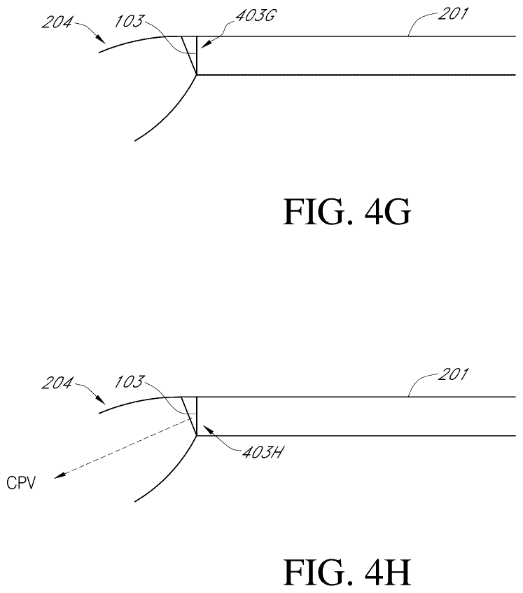

In some implementations, for example shown in FIG. 4A, the aperture(s) 103 are uncovered (e.g., have no filter), so that all the light reflected onto the aperture(s) 103 by one or more of the heliostats 107 of the heliostat fields 102 pass through the aperture(s) 103 into the associated light tubes 201 and directed toward the associated plants (e.g. in the manner shown and described above for FIG. 2).

In some implementations, for example shown in FIG. 4B, an infrared (IR) and band filter 403 can be positioned at or proximate the aperture(s) 103. The IR and band filter 403 rejects or reflects away the unwanted spectrum of light that is not usable by plants. The remaining spectrum of light can continue down the light tubes 201 associated with the aperture(s) 103 toward the associated plants (e.g. in the manner shown and described above for FIG. 2).

In some implementations, for example shown in FIG. 4C, additionally or alternatively, a filter 403C that mirrors (or reflects) the IR or other unwanted spectrum light can be positioned at or proximate the aperture(s) 103. The filter reflects the IR or other unwanted spectrum light to nearby photovoltaic cell(s), such as concentrator photovoltaic cell(s) (CPVs) tuned to the reflected spectrum light, which can generate electricity. In one example, the CPVs can be multiple different CPVs tuned to different spectra that can capture such spectra from the reflected spectrum light (e.g., based on different angles of the filter/mirror). The remaining spectrum of light can continue down the light tubes 201 associated with the aperture(s) 103 toward the associated plants (e.g. in the manner shown and described above for FIG. 2).

In some implementations, for example shown in FIG. 4D, additionally or alternatively, a filter 403D that mirrors (or reflects) the IR can be positioned at or proximate the aperture(s) 103. The filter can reflect the IR to a nearby absorber A to capture heat from said reflected IR light, for example capture the heat in a fluid as discussed further herein. The remaining spectrum of light can continue down the light tubes 201 associated with the aperture(s) 103 toward the associated plants (e.g. in the manner shown and described above for FIG. 2).

In some implementations, for example shown in FIG. 4E, additionally or alternatively, a window 403E is at or proximate the aperture(s) 103. The window 403E can be or include PV cell(s) that convert a particular spectra of the light directed to the aperture(s) 103 to electricity E and let the rest of the light spectrum down the light tubes 201 associated with the aperture(s) 103 toward the associated plants (e.g. in the manner shown and described above for FIG. 2).

In some implementations, for example shown in FIG. 4F, additionally or alternatively, a window 403F is at or proximate the aperture(s) 103. The window 403F can be or include an IR absorber that convert a particular spectra of the light directed to the aperture(s) 103 to heat H, which can be directed to and captured in a heat storage (e.g., in a fluid) as discussed further herein. The rest of the light spectrum down the light tubes 201 associated with the aperture(s) 103 toward the associated plants (e.g. in the manner shown and described above for FIG. 2).

In some implementations, for example shown in FIG. 4G, additionally or alternatively, one or more non-linear crystals 403G can be positioned at or proximate the aperture(s) 103. The non-linear crystal(s) 403G can double the frequency of IR light to cover it to visible light. The visible light can then pass down the light tubes 201 associated with the aperture(s) 103 (along with the rest of the usable light spectra from the light reflected onto the aperture(s) 103) and toward the associated plants (e.g. in the manner shown and described above for FIG. 2).

In some implementations, for example shown in FIG. 4H, additionally or alternatively, one or more mirrors (e.g., dichroic mirrors) 403H can be positioned at or proximate the aperture(s) 103 to redirect or reflect some of the reflected sunlight passing through the aperture(s) 103. The rest of the light spectrum down the light tubes 201 associated with the aperture(s) 103 toward the associated plants (e.g. in the manner shown and described above for FIG. 2).

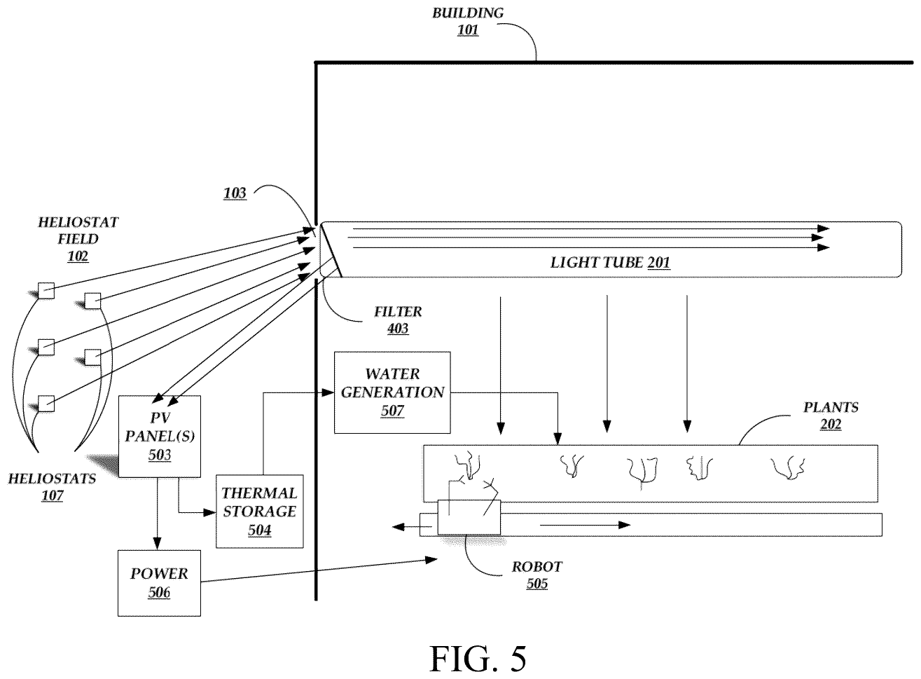

The dichroic mirror can reflect non suitable light (e.g., infrared or other spectrum light that plants do not use) and direct it, for example, towards PV panels 503 (e.g., outside the building 101) to generate electricity, as shown in FIG. 5, that can be used by the building 101, or the non-suitable light can be rejected. The generated electricity can be used as power for the operations inside the building, as further described below. In another example, an infrared (IR) filter at or proximate the aperture(s) 103, as discussed above, can filter IR light off (e.g., without further conversion or collection). In another example, as discussed above, a selective transparent PV cell at or proximate the aperture(s) 103 can directly convert the IR spectrum in the reflected sunlight directed to the aperture(s) 103 to electricity, which can be used as discussed herein.

In some implementations, a portion of the reflected sunlight directed at or passing through the aperture 103 (e.g., a spectrum of light that is not useful to plant growth) is filtered out and converted to heat that is stored in a heat storage medium (e.g., in water in a hot water tank). Such stored heat can be used to maintain the internal environment of the building 101 at a controlled temperature (e.g., for example, at night or during winter). In one example, the hot water can be circulated via pipes in the building 101 by a pump (e.g., operated with electricity generated from the PV panels 503, as discussed herein) to control the temperature of the internal environment in the building 101.

The sides S of the building 101 may be divided into sections, where one section may be a wall without apertures and another section may be a wall with apertures 103. In one implementation, the side S of the building is divided into three sections as depicted in FIG. 1 including the following: a bottom section 104 that is 30 meters tall without apertures, a middle section 105 that is 60 meters tall with apertures, and a top section 106 that is another 30 meters tall without apertures. However, the sides of the building can have other suitable configurations or dimensions, such as a wall with no sections with apertures or a wall with multiple sections with apertures of varying dimensions.

The farming system 100 can include a heliostat field 102 a plurality of heliostats 107, each heliostat 107 including a mirror supported on a shaft or frame. Each heliostat 107 can have a tracking controller to track the position of the sun and an actuator for changing the orientation of the mirror of the heliostat 107 (e.g., to face the sun). The mirror of one or more heliostats 107 in the heliostat field 102 can receive and reflect sunlight from the sun toward an associated aperture 103. A controller can control one or more (e.g., multiple) heliostats 107 in the heliostat field 102 (e.g., control the orientation of the heliostats 107) to direct the reflected sunlight to the associated aperture 103 throughout the day. The controller can control (e.g., by how it orients the heliostat(s) 107) how much light is reflected onto a particular aperture 103 (e.g., based on the type or grow stage of the plant(s) associated with the aperture 103 and light tube 201 connected to the aperture 103).

The heliostat field 102 may be spread out from the building 101 with a radius R. In one example, the radius of the heliostat field 102 is approximately 3 to 4 times the building height H. However, the radius R of the heliostat field 102 can have other suitable dimensions. The heliostat field 102 may have thousands of heliostats 107. However, other suitable number of heliostats 107 in the heliostat field 102 can be used. In one implementation, 100 heliostats 107 may direct reflected sunlight onto one aperture 103. However, this is not meant to be limiting or restricted, as more than 100 or less than 100 heliostats 107 may shine on a single aperture 103.

In an implementation, the system 100 may generate water from the air in the environment inside (or outside) the building 101 (e.g., atmospheric water generation) in order to produce water for the plants. For example, the system 100 may use a method of generating water from the atmosphere. The water generating method can use heat generated from the light being concentrated on the apertures 103 to generate water from the air in the environment. The water may be distributed to the plants via drip irrigation or other water dispersing method. In that way, the building 101 can be self-sufficient or self-sustaining by generating its own water for use in growing the plants, making it unnecessary for the building 101 to connect to a municipal water source or other dedicated water source (e.g., river, lake). Advantageously, this allows the building 101 to operate in remote locations away from dedicated water sources, such as in a remote desert environment.

For example, the water generating method may include flowing air though an adsorbent material so that water condenses out of the air onto the adsorbent material. The method also includes the step of heating the adsorbent material (e.g., with heat from the light directed at the aperture 103 by the heliostats 107) to desorb (e.g., evaporate) the water from the adsorbent material as steam. The method also includes the step of condensing the steam (e.g., in a condenser) as water and collect the water (e.g., in a tank). The collected/stored water can be pumped from the storage tank by a pump (e.g., operated using power generated by the PV panels 503 discussed above) and selectively distributed to plants 202 in the building 101 via the drip irrigation or other delivery system. A controller (not shown), also powered by electricity generated by the PV panels 503, can control the operation of the pump to control the timing, frequency and/or amount of irrigation of the plants.

In one implementation, the light tubes 201 described herein may include or be made of glass. In another implementation, the light tubes 201 may be or may include fiber optic tubes. In another implementation, the light tubes 201 may include or be made of a plastic material. In another implementation, the light tubes 201 can include or be made of mirrors). The light tubes 201 can have other suitable structure or materials that allows them to transmit light. However, the light tubes 201 can be made of other suitable materials that allow the distribution of light to plants 202 as discussed herein.

In one implementation, the plants 202 inside the building 101 may be separated by walls inside the building 101 (e.g., in separate rooms and/or on different levels or floors inside the building). The plants may be organized by room, floor, or level according to the aperture 103 the plants 202 are affiliated with, or by type of plant. For example, a light tube 201 of an aperture 103 may shine a high amount of light and therefore, the plants below that light tube 201 can be plants that require a high amount of light (e.g., seedlings or younger plants). In one implementation, the light tubes 201 can extend along the entire length L of the building 101.

As discussed above, in some implementations a filter or an infrared photovoltaic (IR PV) device can be located at or proximate the aperture 103. The filter or IP PV device can filter out undesired wavelengths from the incoming light at the aperture 103. For example, plants do not use certain spectrums of light for growth, such as infrared light. Therefore, in one example, the filter can prevent infrared light from entering the light tube 201. However, the filter may filter out other spectrums of light in other implementations. For example, the filter may allow blue, green, and red light to pass through to the light tube 201 and the PV device absorbs infrared light and generates electricity that can be used in the operation of pumps, robots and/or controllers as discussed herein. In this way, by allowing the appropriate spectrums to pass through the light tube(s) 201 through to the plants 202, while filtering out spectrums that are not needed by the plants and using these to generate electricity or heat, the system 100 advantageously utilizes the entire spectrum of sunlight directed at the aperture(s) 103 by the heliostats 107 of the heliostat field 102.

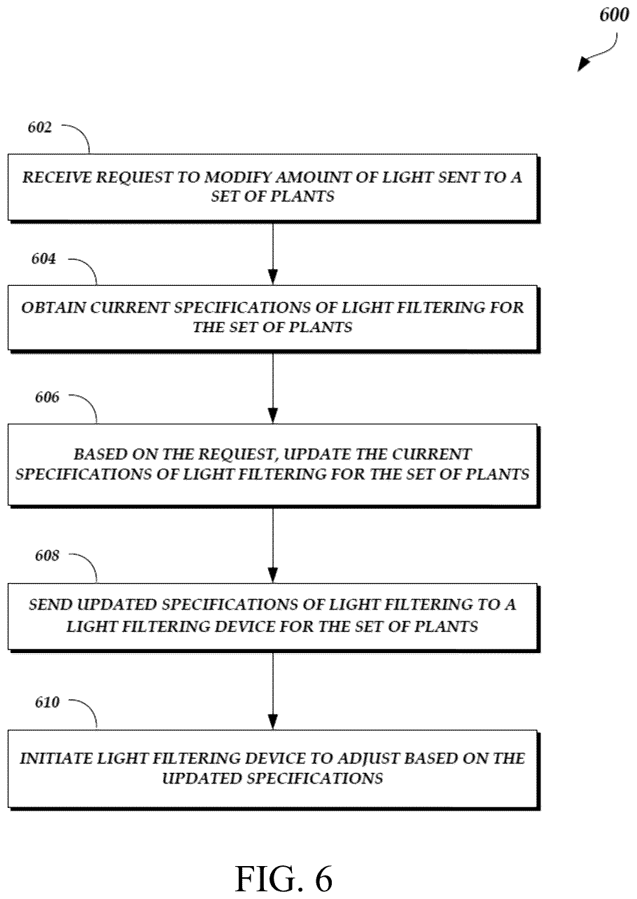

As described above, the apertures 103 may have varying sizes (e.g., have a size that is selectively adjustable). The building 101 can have a mechanism to change the size of the apertures or aperture coverings as to vary the amount of light and intensity of light entering the light tubes 201, as described below with respect to FIG. 6. For example, if a plant (e.g., seedling) needs more light than currently provided, the aperture or covering can increase in size to allow more light in. Alternatively, if the plant (e.g., full grown or mature plant) needs less light than currently provided, the aperture or covering can decrease in size to allow less light in. In one implementation, the apertures 103 may have moving shutters or other adjustable window coverings that can (e.g., alter the size of the aperture to) block some or all of the light from entering the light tube 201. The mechanism by which the aperture 103 or covering changes in size may be controlled electronically (e.g., by an electronic controller, a computer processor, etc.) using the electricity generated by the PV panel(s) 503 (as discussed herein). However, in other examples, the size of the aperture 103, or position of the covering, can be controlled manually by a user (to change the size of the aperture 103) to vary the amount of sunlight passing into the light tube 201. In other examples, the shutter can be a liquid crystal or an electrically tunable shutter or filter (e.g., need not be a mechanical shutter or mechanically actuated).

FIG. 5 shows a schematic view of an implementation of the indoor farming system 100. In the implementation depicted in FIG. 5, the building 101 has a light tube 201 providing light to the plants 202. In this implementation, a portion of the light from the heliostats 107 in the heliostat field 102 directed to the aperture 103 is sent through the light tube 201 for shining on the plants 202, and a portion of the light is reflected via a filter 403 (e.g., reflector or dichroic mirror) to PV panel(s) 503 to generate electricity and/or converted to heat that is stored in thermal storage unit 504 (e.g., heat is used to heat water that is stored in a hot water tank). The PV panel(s) 503 are depicted in FIG. 5 as located outside the building 101. However, this is not meant to be limiting or restricted, and the system 100 can exclude one or more of the subsystems described herein (e.g., thermal storage, power storage, PV panels). In another implementation, the PV panel(s) 503 may be located inside the building 101. The electricity generated from the PV panel(s) 503 may optionally be stored in a power storage 506. The heat stored in the thermal storage unit 504 may be used for water generation 507, as described above. The water generated can be used for irrigation to give water to the plants 202.

In one implementation, the farming operation may utilize one or more robots 505 to control the farming operations of the building. For example, the robots 505 may tend to the plants 202. In an example, as depicted in FIG. 5, the robot 505 may move alongside the plants 202 on a conveyer belt or along a rail proximate (adjacent) the rows of plants 202 as it tends to each plant 202. The robots 505 may be powered through electricity that is generated via the PV panels 503 and stored in the power storage 506.

FIG. 6 is a flowchart of an illustrative process 600 for controlling how much light goes to the plants in the system 100. The process 600 includes receiving a request to modify the amount of light going to a set of plants and subsequently, updating the light filtering specifications and initiating a light filtering device to adjust.

The process 600 begins at block 602 by receiving a request to modify the amount of light sent to a set of plants. The process 600 may begin automatically upon initiating a device, or may be initiated by a client or end-user on an ad hoc basis. The client or end user may use an interactive system to initiate the process 600. For example, a client or end-user may request the modification of the amount of light being sent to the plants when desired by the client or end-user using the interactive system. The process 600 may also be initiated automatically based on a routine schedule (e.g., every hour, day, or week, etc.), in response to a triggering event, or both. For example, a routine schedule may set the process 600 to automatically be performed every three months (for example, because the amount of sunlight changes based on the season) and therefore, the process 600 may be performed every three months according to the set schedule. Additionally, the triggering event may be manually entered into the network from a client or end-user, or automatically entered from the robot(s). A triggering event, for example, may be a new plant event, a burnt plant event, etc., where an event occurrence in the network triggers initiation of the process 600.

The process 600 may be embodied in a set of executable program instructions stored on a computer-readable medium, such as one or more disk drives of a computing system of a node or a server. When the process 600 is initiated, the executable program instructions can be loaded into memory, such as random access memory (“RAM”), and executed by one or more processors of a computing system.

At block 604, a computing device executing the process 600 obtains the current specifications of light filtering for the set of plants. For example, an aperture associated with this set of plants may have a moveable covering (e.g., a window shutter) that allows a certain amount of light to enter the light tube. The current specifications may indicate the placement of the covering over the aperture or amount of covering (e.g., 50% covered).

At block 606, the computing device executing the process 600 updates the current specifications of light filtering for the set of plants based on the request. For instance, if the current specifications indicate that the aperture should be 50% covered, but the request indicates that more light should be sent to the set of plants, the specifications may be updated to less than 50% covered.

At block 608, the computing device executing the process 600 sends the updated specifications of light filtering to a light filtering device (e.g., the moveable covering or shutter described above) for the set of plants. With those updated specifications, at block 608, the computing device executing the process 600 can initiate the light filtering device to adjust. For example, if the updated specifications indicate that the aperture should be 30% covered, then the light filtering device is triggered by the computing device executing the process 600 to open to cover to 30%.

Advantageously, the system 100 uses the entire spectrum of sunlight to provide a self-sustaining farming environment that can operate in remote locations (e.g., desert) using only sunlight to grow plants. The system 100 advantageously does not require a dedicated water source (e.g. municipal water source, river, etc.) as it can generate water from air, as described above. Also, the system 100 advantageously does not require connection to the power grid as it can generate electricity (using PV panels) to power electronics and machines (e.g., pumps, robots) in the building 101.

While certain implementations of the inventions have been described, these implementations have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, implementation, or example are to be understood to be applicable to any other aspect, implementation or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some implementations, the actual steps taken in the processes illustrated and/or disclosed may differ from those shown in the figures. Depending on the implementation, certain of the steps described above may be removed, others may be added. Furthermore, the features and attributes of the specific implementations disclosed above may be combined in different ways to form additional implementations, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular implementation. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations or that one or more implementations necessarily include logic for deciding, with or without user input or prompting, whether these features, elements, and/or steps are included or are to be performed in any particular implementation.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of the stated amount. As another example, in certain implementations, the terms “generally parallel” and “substantially parallel” refer to a value, amount, or characteristic that departs from exactly parallel by less than or equal to 15 degrees.

The scope of the present disclosure is not intended to be limited by the specific disclosures of preferred implementations in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described In detail, other modifications and methods of use, which are within the scope of this invention, will be readily apparent to those of skill in the art based upon this disclosure. It is contemplated that various combinations or subcombinations of these specific features and aspects of implementations may be made and still fall within the scope of the invention. Accordingly, it should be understood that various features and aspects of the disclosed implementations can be combined with or substituted for one another in order to form varying modes of the discussed devices.

What is claimed is:

1. A self-sustaining farming system, comprising:
a heliostat field comprising a plurality of heliostats;
a building proximate the heliostat field, the building having an aperture on a side of the building, the aperture configured to receive reflected sunlight from one or more of the plurality of heliostats in the heliostat field;
a compound parabolic concentrator proximate the aperture and configured to direct and concentrate the reflected sunlight onto the aperture; and
a light tube extending into the building from the aperture, the light tube configured to direct light along a length of the light tube and direct said light via one or more concentrators onto one or more plants disposed inside the building.

2. The system of claim 1, further comprising a filter configured to filter a portion of said sunlight passing through the aperture and direct it to a photovoltaic panel to generate one or both of heat and electricity.

3. The system of claim 2, wherein the filter is a dichroic mirror.

4. The system of claim 1, further comprising a heat storage unit configured to store heat.

5. The system of claim 4, wherein said heat from the heat storage unit is used to control a temperature inside the building.

6. The system of claim 1, wherein a size of the aperture is selectively adjustable to adjust an amount and intensity of light passing through the aperture and into the light tube.

7. The system of claim 1, wherein the aperture is a plurality of spaced apart apertures on the side of the building.

8. A self-sustaining farming system, comprising:
a building proximate having an aperture on a side of the building, the aperture configured to receive reflected sunlight from one or more heliostats;
a compound parabolic concentrator proximate the aperture and configured to direct and concentrate the reflected sunlight onto the aperture; and
a light tube extending into the building from the aperture, the light tube configured to direct light along a length of the light tube and direct said light via one or more concentrators onto one or more plants disposed inside the building.

9. The system of claim 8, further comprising a filter configured to filter a portion of said sunlight passing through the aperture and direct it to a photovoltaic panel to generate one or both of heat and electricity.

10. The system of claim 9, wherein the filter is a dichroic mirror.

11. The system of claim 8, further comprising a heat storage unit configured to store heat.

12. The system of claim 11, wherein said heat from the heat storage unit is used to control a temperature inside the building.

13. The system of claim 8, wherein a size of the aperture is selectively adjustable to adjust an amount and intensity of light passing through the aperture and into the light tube.

14. The system of claim 8, wherein the aperture is a plurality of spaced apart apertures on the side of the building.

15. A self-sustaining farming system, comprising:
a building having an aperture on a side of the building, the aperture configured to receive reflected sunlight from one or more heliostats; and
a light tube extending into the building from the aperture, the light tube configured to direct light along a length of the light tube and direct said light via one or more concentrators onto one or more plants disposed inside the building.

16. The system of claim 15, further comprising a filter configured to filter a portion of said sunlight passing through the aperture and direct it to a photovoltaic panel to generate one or both of heat and electricity.

17. The system of claim 15, further comprising a heat storage unit configured to store the heat.

18. The system of claim 17, wherein said heat from the heat storage unit is used to control a temperature inside the building.

19. The system of claim 15, wherein a size of the aperture is selectively adjustable to adjust an amount and intensity of light passing through the aperture and into the light tube.

20. The system of claim 15, wherein the aperture is a plurality of spaced apart apertures on the side of the building.
